(19) United States
(12) Patent Application Publication
(10) Pub. No.: US 2022/0303114 A9
(43) Pub. Date: Sep. 22, 2022

(54) FORMAT-PRESERVING ENCRYPTION METHOD BASED ON STREAM CIPHER

(71) Applicant: Guizhou University, Guiyang City (CN)

(72) Inventors: Changgen PENG, Guiyang City (CN); Jia CHEN, Guiyang City (CN); Hongfa DING, Guiyang City (CN); Yuanyuan ZHAO, Guiyang City (CN)

(73) Assignee: Guizhou University, Guiyang City (CN)

(21) Appl. No.: 17/018,676

(22) Filed: Sep. 11, 2020

(30) Foreign Application Priority Data
Oct. 30, 2019 (CN) 201911042942.5

(51) Int. Cl. H04L 9/06

(52) U.S. Cl. CPC H04L 9/065

(57) ABSTRACT

The disclosure proposes a format-preserving encryption method based on a stream cipher. In this method, the first three digits of an area code are encrypted by segmenting a phone number, creating mapping rules, and establishing an area code permutation table for the first three digits of the area code, thereby ensuring a legality of an encryption result; an accuracy of encryption and decryption is ensured by performing an XOR operation on a key stream generated from the ZUC algorithm (i.e., Zu Chongzhi's algorithm) and the last seven or eight digits of the phone number, combining a modulo operation to achieve conformal encryption, and introducing a Lagrange interpolation formula. This method securely and effectively realizes a consistency and legitimacy of data formats before and after encryption, and well hides statistical characteristics of plaintext, so that data is protected during a transmission process without changing the formats.

### CROSS-REFERENCE TO RELATED APPLICATION

This application claims the priority of Chinese Patent Application No. 201911042942.5, entitled “Format-Preserving Encryption Method Based on Stream Cipher”, filed on Oct. 30, 2019, the content of which is incorporated herein by reference in its entirety.

### TECHNICAL FIELD

The disclosure relates to the technical field of information security, in particular to a format-preserving encryption method based on stream cipher for use in securing data transmitted by computing devices.

### BACKGROUND

In the era of big data and cloud computing, many applications and social media software used in life not only brings convenience to us, but also collects our data information at all times. This data may include sensitive data of a personal nature, such as a user's phone number, which is sensitive data information that is bound to be collected. The phone number is easily stolen and used by criminals due to the high value thereof. Once the phone number is stolen, misuse of the phone number is likely to cause property damage or life troubles, such as by criminals targeting the owner of the phone number in an attempt to get the owner to transfer funds to a designated account by sending text messages tricking the owner into believing they have won a contest, or tricking the owner into assisting “public security investigations”, or by the criminals impersonating others who need to transfer money in a hurry for urgent use, etc., all for the purpose of profiteering through fraud. In September 2019, a database of Facebook storing hundreds of millions of phone numbers associated with Facebook accounts was leaked online, resulting in 490 million of Facebook's users being placed at risk of spam calls and SIM exchange attacks, where attackers can force users to reset any Internet account number and password associated with the phone number, posing a security risk that is difficult to predict. Therefore, in order to prevent the phone numbers of users from being stolen by malicious attackers, the phone numbers need to be encrypted and protected. Traditional encryption technology tends to destroy the original structure of data, change a type and length of encrypted ciphertext data, and reduce availability of data. Format-Preserving Encryption (FPE) algorithms render an encrypted ciphertext with the same format as the plaintext data without destroying the data structure, and are widely used in data masking, payment card industry security, and format-compatible encryption fields, etc. Therefore, Format-Preserving Encryption for sensitive data, such as phone numbers, not only prevents malicious people from judging the authenticity of the data, but also does not reduce the availability of ciphertext data, and further ensures the security of data during transmission and storage. As such, further development into Format-Preserving Encryption techniques is desired in order to develop techniques for using it to help protect users' phone numbers.

### SUMMARY

The disclosure proposes a format-preserving encryption method based on a stream cipher, which can make a phone number to be encrypted retain the original data format characteristics after encryption, and still present as a legal phone number. This method can solve the problems inherent to application of traditional encryption technology to phone numbers, for example that it tends to change the length and type of ciphertext, thereby reducing data availability and affecting database structure and business system functions.

The disclosure is implemented as follows: a format-preserving encryption method based on stream cipher and implemented on a computing device, including steps of:

1) dividing a legal phone number into two parts including the first digits (for example, three digits) and the last digits (for example, seven or eight digits); and searching area codes of all legal phone numbers and creating a sorting rule to establish a corresponding area code permutation table by one-to-one mapping between a sequence number and the area code;

2) performing a summation and modulo-addition operation on a sequence number corresponding to a plaintext area code according to the permutation table established in the step 1) and the last plaintext digits (for example, the last seven or eight digits), to obtain an operation result as a new sequence number; and obtaining a new area code corresponding to the new sequence number according to the permutation table, as an encrypted ciphertext of the plaintext area code;

3) converting each of the last digits (for example, the last seven or eight digits) of the phone number to a 4-bit binary number with insufficient highest bits filled with zero, to obtain a 32-bit binary number; then performing an XOR operation on the 32-bit binary number and a key stream of a ZUC algorithm; dividing an XOR result from right to left into groups of 4 bits with insufficient highest bits filled with zero and converting each of the groups into a decimal integer to be divided into 8 groups, performing a modulo-10 addition operation on divided results to obtain a conformal ciphertext data; further, based on a Lagrange interpolation formula, creating a polynomial on a prime field Z₁₇ by using the 8 groups of decimal numbers as secret values; and obtaining corresponding auxiliary data required during decryption by entering independent variables x in the polynomial;

4) connecting encrypted results obtained in the step 2) and the step 3) to obtain a legal ciphertext telephone number;

5) dividing the auxiliary data outputted in the step 3) into groups of 2 numbers for operation; taking out a first digit and remaining digits of each decimal auxiliary data as value x and value y respectively; performing a modulo operation by using the Lagrange interpolation formula; converting each of results of the modulo operation to a 4-bit binary number with insufficient highest bits filled with zero, to finally obtain a 32-bit binary number; performing an XOR operation on the 32-bit binary number and the key stream of the ZUC algorithm to obtain an XOR result; dividing the XOR result from right to left into groups of 4 bits with insufficient highest bits filled with zero, and converting each of the groups into a decimal integer, to be divided into 8 groups; and performing a modulo-10 subtraction operation on divided results to obtain a conformal plaintext data of the last digits (for example, seven or eight digits);

6) searching a sequence number corresponding to a ciphertext area code obtained in the step 2) according to the permutation table established in the step 1); summing the last digits (for example, seven or eight digits) obtained in the step 5) and performing a modulo-subtraction operation with the sequence number corresponding to the ciphertext area code obtained in the step 2); and restoring the plaintext area code by mapping a result of the modulo-subtraction operation to the permutation table; and

7) connecting decrypted results obtained in the step 5) and the step 6) to obtain a legal and correct decrypted plaintext telephone number.

Optionally, in the step 3), in order to achieve correctness of a decryption algorithm, the polynomial on the prime field Z₁₇ is created by using the 8 groups of decimal numbers as secret values to obtain the auxiliary data required during decryption.

Optionally, in the steps 3) and 5), in order to achieve legitimacy and correctness of data encryption and decryption, the polynomial on the prime field Z₁₇ is created based on an idea of a secret sharing scheme, and the Lagrange interpolation formula is used to perform auxiliary recovery on ciphertext data.

Due to the adoption of the above technical solution, compared with the prior art, the disclosure can make the user's phone number retain the original data format characteristics after encryption, and still present as a legal phone number, and further can solve the problem that traditional encryption technology tends to change the length and type of ciphertext. Format-Preserving Encryption for sensitive data, such as phone numbers, not only prevents malicious people from judging the authenticity of the data, but also does not reduce the availability of ciphertext data and affect database structure and business system functions. In addition, this method expands the applicability of the ZUC algorithm. The disclosure is constructed based on the stream cipher ZUC algorithm. Due to the rapid real-time nature of the generation of the streaming key of the ZUC algorithm and the low complexity of hardware and software implementation thereof, the ZUC algorithm effectively hides the plaintext statistical features, and has higher encryption and decryption efficiency and performance, helping to increase the data security provided by the computing device to the user.

### BRIEF DESCRIPTION OF THE DRAWINGS

FIG. 1 is a schematic diagram of the encryption process of the disclosure; and

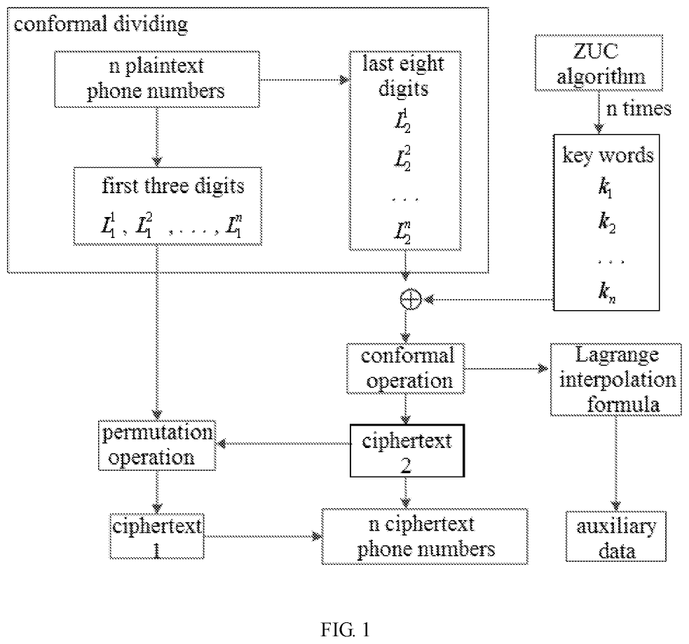

FIG. 2 is a schematic diagram of the decryption process of the disclosure.

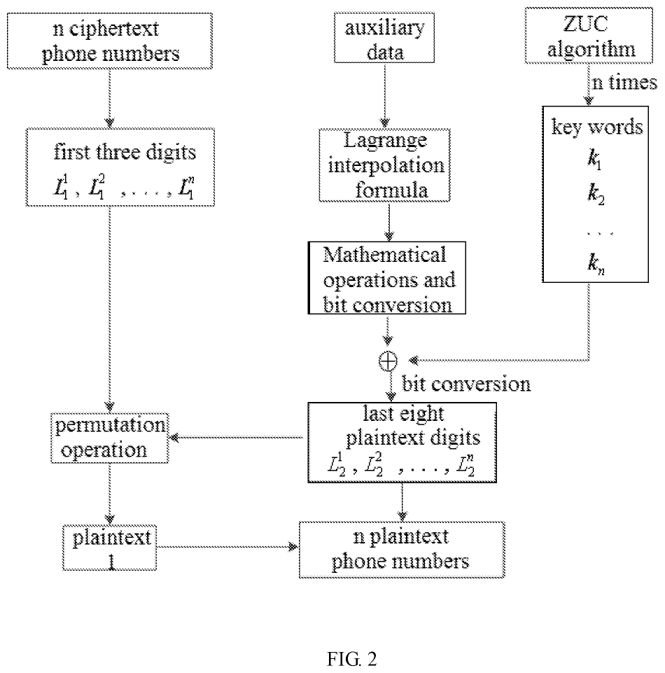

### DETAILED DESCRIPTION OF THE EMBODIMENTS

An embodiment of the disclosure: the format-preserving encryption method based on stream cipher proposed in the disclosure is used to encrypt and decrypt a telephone number (for example, 10 or 11 digits) in plaintext, and the ZUC algorithm is selected among the stream cipher algorithms. The structure of the ZUC algorithm is divided into three layers, that is, upper, middle, and lower layers, wherein the upper layer is a 16-level Linear Feedback Shift Register (LFSR), the middle layer is Bit Reorganization (BR), and the lower layer is a nonlinear function (F). The ZUC algorithm is a stream cipher (sequence cipher). Each time the ZUC algorithm is input with a 128-bit initial key and a 128-bit initial vector, a 32-bit key word sequence is generated, wherein a bit string of 2 or more bits is called a word. The plaintext to be encrypted is grouped according to a required length, and then the plaintext message groups are respectively encrypted with the key stream generated by the encryption algorithm, so as to obtain a corresponding ciphertext.

A description below is for an encryption algorithm of the format-preserving encryption method based on stream cipher:

```
    Algorithm 1: The encryption process of the format-preserving encryption method based
on stream cipher of Embodiment 1 (taking an 11-digits telephone number as an example)
includes the following steps listed below, provided with the inputs and outputs listed below:
    Input: initial key K = (key,x₁,x₂,x₃) ; initial vector iv; plaintext integer M ;
    Output: integer C; integers R₁, ..., R₁₆;
    1. M = L₁ ∥ L₂, L₁ = N₁ ∥ N₂ ∥ N₃, L₂ = N₄ ∥ ... ∥ N₁₁ ;
    2. Tₜ ← L₁, IF t ↔ L₁ ;
    3. For i ← 1 to 8 do
  i. s₀ = t ;
  ii. sᵢ = sᵢ₋₁ + Nᵢ₊₃ ;
    4. s = s₈ mod 49 ; s ↔ Tₛ;
    5. L′_{bin} ← codeBin(L₂,4) ;
    6. P ← ZUC(key,iv) ⊕ L′_{bin} ;
    7. DEC(P₁,P₂,...,P₈) ← Split(P,4) ;
    8. For ← 1 to 8 do
  i. Pᵢ′ = (Pᵢ + 1) mod 10 ;
  ii. gⱼ (xⱼ) ← (aᵢxⱼ + Pᵢ + 1) mod 17 ;
  iii. For j ← 1 to 8 do
    gⱼ (xⱼ) ← (aᵢxⱼ + Pᵢ + 1) mod17 ;
    yⱼ ← j ∥ gⱼ(xⱼ) ; ^{_{;}}
  iv. yᵢ₁,yᵢ₁ ← random(y₁,y₂,y₃,2) ;
  v. Return yᵢ₁ , yᵢ₂ ;
    9. C ← Tₛ ∥ P₁′ ∥ ... ∥ P₈′; ^{_{;}}
    10. Return C.
```

In Algorithm 1, M represents a plaintext decimal integer (for example, 10 bit or 11 bit), key represents a key with a length of 128 bits, and iv represents a 128-bit initial vector. The format-preserving encryption method based on stream cipher includes the encryption of the first three digits of the area code, the encryption of the last seven or eight digits, and the output of auxiliary data.

Encryption of the first three digits of the area code: searching all legal area codes, and sorting all legal area codes according to a certain rule; establishing a permutation table by establishing a one-to-one mapping between the sequence numbers and the area codes, to search a sequence number corresponding to an area code; using a modulo operation to perform relevant calculations on the sequence number corresponding to the area code to obtain a new sequence number; and further mapping the new sequence number to a new area code, so as to complete an encryption permutation between the area codes.

Encryption of the last seven or eight digits: denoting each digit as a 4-bit binary number with insufficient highest bits filled with zero, to obtain a 32-bit binary number, the process for which is denoted as codeBin( ) in Algorithm 1; and then performing an XOR operation on the 32-bit binary number and a key stream of the ZUC algorithm; dividing the XOR result from right to left into groups of 4 bits (with insufficient highest bits filled with zero), and converting each of the groups into a decimal integer to split into 8 groups, which process is represented as Split( ); and performing relevant modulo operations on split results to obtain a conformal ciphertext data.

Output of auxiliary data: In order to achieve the correctness of the decryption algorithm, based on the Lagrange interpolation formula, construct a polynomial on a prime field Z₁₇ by using the 8 groups of decimal numbers during encryption as secret values to obtain the auxiliary data required during decryption.

```
    Algorithm 2: The decryption process of the format-preserving encryption method based
on stream ciphers of Embodiment 1 (taking an 11-digits telephone number as an example);
    Input: initial key K = (key,x₁,x₂,x₃) ; initial vector iv; ciphertext integer M ; integers
R₁,...,R₁₆;
    Output: integer C;
    1. M = L₁ ∥ L₂, L₁ = N₁ ∥ N₂ ∥ N₃, L₂ = N₄ ∥ ... ∥ N₁₁ ;
    2. For ← 1 to 8 do
  i. x₁ ← F(Rᵢ) ; x₂ ← F(Rᵢ₊₁) ;
  ii. y₁ ← W (Rᵢ) ; y₂ ← W(R₊₁) ;
  iii. yᵢ ← y₁ · x₂ · (x₂ − x₁)⁻¹ + y₂ · x₁ · (x₁ − x₂)⁻¹ ; yᵢ ← yᵢ mod17 − 1 ;
  iv. Bᵢ ← bin(yᵢ,4) ;
    3. P ← ZUC(key,iv) ⊕ (B₁ ∥ ... ∥ B₈) ; ^{_{;}}
    4. DEC(P₁,P₂,...,P₈) ← Split (P,4) ;
    5. Tₜ ← L₁, IF t ↔ L₁;
    6. For i ← 1 to 8 do
  i. s₀ = t ;
  ii. sᵢ = sᵢ₋₁ − Pᵢ ;
    7. s = s₈ mod49 ; s ↔ Tₛ ;
    8. C ← Tₛ ∥ P₁ ∥ ... ∥ P₈ ;
    9. Return C.
```

In Algorithm 2, C represents an 11-bit plaintext decimal integer, key represents a key with a length of 128 bits, and iv represents a 128-bit initial vector. The format-preserving decryption method based on stream cipher includes the decryption of the first three digits of the area code and the decryption of the last seven or eight digits.

Decryption of the last seven or eight digits: by means of the auxiliary data, dividing the auxiliary data into groups of 2 numbers for operation; taking out the first digit and remaining digits of each decimal auxiliary data respectively by using F function and W function to enter into the Lagrange interpolation formula to perform the relevant modulo operations; converting each digit to a 4-bit binary number with the insufficient highest bits filled with zero, to obtain a 32-bit binary number, which process is represented as bin( ) in Algorithm 2; and then performing an XOR operation on the 32-bit binary number and the key stream of the ZUC algorithm; dividing the XOR result from right to left into groups of 4 bits, and converting each of the groups into a decimal integer to split into 8 groups, which process is represented as Split( ); and performing a relevant modulo operation on the split results to obtain a conformal plaintext data.

Decryption of the first three digits of the area code: searching a sequence number corresponding to the ciphertext area code; performing a relevant modulo operation on the sequence number and 7 or 8 plaintext decimal numbers obtained during the steps 5)-7) to obtain a new sequence number; obtaining a corresponding plaintext area code according to the permutation table between the sequence numbers and the area codes, so as to realize the decryption of the ciphertext area code.

For a clearer explanation of Embodiment 1 of the disclosure, the format-preserving encryption method based on stream cipher according to the disclosure is used to encrypt and decrypt the legal plaintext phone number “13045327653” with the detailed process thereof shown as follows. Select the initial key key=0x0000000000000000, initial vector iv=0x0000000000000000, and fixed values x₁=1, x₂=2, x₃=3.

TABLE 1
Creation of a permutation table between
sequence numbers and area codes

| | | | | | | | | | | | |
|---|---|---|---|---|---|---|---|---|---|---|---|
| sequence | | | | | | | | | | 0 | 1 |
| numbers | | | | | | | | | | | |
| area | 30 | 31 | 32 | 33 | 34 | 35 | 36 | 37 | 38 | 39 | 40 |
| codes | | | | | | | | | | | |
| sequence | 2 | 3 | 4 | 5 | 6 | 7 | 8 | 9 | 0 | 1 | 2 |
| numbers | | | | | | | | | | | |
| area | 45 | 46 | 47 | 49 | 50 | 51 | 52 | 53 | 55 | 56 | 57 |
| codes | | | | | | | | | | | |
| sequence | 3 | 4 | 5 | 6 | 7 | 8 | 9 | 0 | 1 | 2 | 3 |
| numbers | | | | | | | | | | | |
| area | 58 | 59 | 62 | 65 | 66 | 67 | 70 | 71 | 72 | 73 | 75 |
| codes | | | | | | | | | | | |
| sequence | 4 | 5 | 6 | 7 | 8 | 9 | 0 | 1 | 2 | 3 | 4 |
| numbers | | | | | | | | | | | |
| area | 76 | 77 | 78 | 80 | 81 | 82 | 83 | 84 | 85 | 86 | 87 |
| codes | | | | | | | | | | | |
| sequence | 5 | 6 | 7 | 8 | 9 | | | | | | |
| numbers | | | | | | | | | | | |
| area | 88 | 89 | 91 | 98 | 99 | | | | | | |
| codes | | | | | | | | | | | |

The phone number is divided into 2 parts: L₁=130, L₂=45327653;

The sequence number corresponding to the area code 130 is determined as 1 according to the permutation table: 130↔1;

The corresponding sequence number and the last eight digits of the phone number are summed, to perform the modulo-addition operation:

$$s = ( 1 + {\sum }_{i = 4}^{11} {N}_{i} ) mod 49 = 36 ;$$

The area code corresponding to the sequence number 36 is determined as 178, i.e., the area code ciphertext Tₛ=178;

The plaintext “45327653” is operated by codeBin( ) to get a plaintext stream: (01000101001100100111011001010011)₂;

The initial key and the initial vector are entered into the ZUC algorithm to be run once, and a key stream (00100111101111101101111001110100)₂ is output;

An XOR operation is performed on the plaintext stream and the key stream:

(01000101001100100111011001010011)₂⊕(00100111101111101101111001110100)₂=(0 1100010100011001010100000100111)₂;

The XOR result is operated by Split( ) to get decimal integers: 6,2,8,12,10,8,2,7;

A relevant modulo operation is performed on the split results:

(6+1)mod 10=7, (2+1)mod 10=3, (8+1)mod 10=9, (12+1)mod 10=3,

(10+1)mod 10=1, (8+1)mod 10=9, (2+1)mod 10=3, (7+1)mod 10=8;

A final ciphertext of the phone number is obtained as: 17873931938 to complete the encryption.

Auxiliary data are output based on a polynomial function g(x)=(xᵢ·aᵣ+hᵣ)mod 17 (1≤r≤8, 1≤i≤3). To facilitate the description of the process of the output of auxiliary data, it is assumed that for each hᵣ, a random number 1≤aᵣ≤10 is randomly generated:

when h₁=7, a₁=1, and thus g(x₁)=8, g(x₂)=9 and g(x₃)=10, 18 and 310 are randomly output;

when h₂=3, a₂=1, and thus g(x₁)=4, g(x₂)=5 and g(x₃)=6, 14 and 25 are randomly output;

when h₃=9, a₃=3, and thus g(x₁)=12, g(x₂)=15 and g(x₃)=2, 112 and 215 are randomly output;

when h₄=13, a₄=2, and thus g(x₁)=15, g(x₂)=10 and g(x₃)=2, 210 and 32 are randomly output;

when h₅=11, a₅=8, and thus g(x₁)=2, g(x₂)=10 and g(x₃)=1, 12 and 31 are randomly output;

when h₆=9, a₆=5, and thus g(x₁)=14, g(x₂)=2 and g(x₃)=7, 22 and 37 are randomly output;

when h₇=3, a₇=7, and thus g(x₁)=10, g(x₂)=0 and g(x₃)=7, 110 and 20 are randomly output; and

when h₈=8, a₈=4, and thus g(x₁)=12, g(x₂)=16 and g(x₃)=3, 112 and 33 are randomly output.

Decryption: dividing the ciphertext “17873931938” into 2 parts: L₁=178, L₂=73931938;

Dividing the auxiliary data into groups of two numbers to perform the operations by the F function and the W function on the groups:

The first group: 18, 310, then x₁=1, x₂=3, y₁=8, y₂=10, and according to the Lagrange interpolation formula, a calculation is performed as follows:

$$( 8 \cdot \frac{3}{3 - 1} + 10 \cdot \frac{1}{1 - 3} ) mod 17 - 1 = ( 24 \cdot 9 + 10 \cdot 8 ) mod 17 - 1 = 6 ;$$

The second group: 14, 25, then x₁=1, x₂=2, y₁=4, y₂=5, a calculation is performed as follows:

$$( 4 \cdot \frac{2}{2 - 1} + 5 \cdot \frac{1}{1 - 2} ) mod 17 - 1 = ( 8 \cdot 18 + 5 \cdot 16 ) mod 17 - 1 = 2 ;$$

The third group: 112, 215, then x₁=1, x₂=2, y₁=12, y₂=15, a calculation is performed as follows:

$$( 12 \cdot \frac{2}{2 - 1} + 15 \cdot \frac{1}{1 - 2} ) mod 17 - 1 = ( 24 \cdot 18 + 15 \cdot 16 ) mod 17 - 1 = 8 ;$$

The fourth group: 210, 32, then x₁=2, x₂=3, y₁=10, y₂=2, a calculation is performed as follows:

$$( 10 \cdot \frac{3}{3 - 2} + 2 \cdot \frac{2}{2 - 3} ) mod 17 - 1 = ( 30 \cdot 18 + 4 \cdot 16 ) mod 17 - 1 = 12 ;$$

The fifth group: 12, 31, then x₁=1, x₂=3, y₁=2, y₂=1, a calculation is performed as follows:

$$( 2 \cdot \frac{3}{3 - 1} + 1 \cdot \frac{1}{1 - 3} ) mod 17 - 1 = ( 6 \cdot 9 + 1 \cdot 8 ) mod 17 - 1 = 10 ;$$

The sixth group: 22,37, then x₁=2, x₂=3, y₁=2, y₂=7, a calculation is performed as follows:

$$( 2 \cdot \frac{3}{3 - 2} + 7 \cdot \frac{2}{2 - 3} ) mod 17 - 1 = ( 6 \cdot 18 + 14 \cdot 16 ) mod 17 - 1 = 8 ;$$

The seventh group: 110, 20, then x₁=1, x₂=2, y₁=10, y₂=0, a calculation is performed as follows:

$$( 10 \cdot \frac{2}{2 - 1} + 0 \cdot \frac{1}{1 - 2} ) mod 17 - 1 = ( 20 \cdot 18 + 0 ) mod 17 - 1 = 2 ;$$

The eighth group: 112,33, then x₁=1, x₂=3, y₁=12, y₂=3, a calculation is performed as follows:

$$( 12 \cdot \frac{3}{3 - 1} + 3 \cdot \frac{1}{1 - 3} ) mod 17 - 1 = ( 36 \cdot 9 + 3 \cdot 8 ) mod 17 - 1 = 7.$$

The calculation results of 6, 2, 8, 12, 10, 8, 2, 7 can be operated by codeBin( ) to obtain (01100010100011001010100000100111)₂;

The initial key and the initial vector are input into the ZUC algorithm to be run once, and the key stream (00100111101111101101111001110100)₂ is output and XORed with the above obtained value:

(00100111101111101101111001110100)₂⊕(01100010100011001010100000100111)₂=(01000101001100100111011001010011)₂;

The XOR result is operated by Split( ) to obtain the plaintext data of the last eight digits: 4,5,3,2,7,6,5,3;

A sequence number corresponding to the area code ciphertext 178 according to the permutation table is 36: 178↔36;

The plaintext data of the last eight digits 4,5,3,2,7,6,5,3 are summed to perform a modulo-subtraction operation with the sequence number 36:

$$s = ( 36 - {\sum }_{i = 4}^{11} {N}_{i} ) mod 49 = 1 ;$$

An area code corresponding to the sequence number 1 is 130, that is, the plaintext area code is 130;

Therefore, the plaintext is decrypted as 13045327653 to complete the decryption.

The disclosure ensures the legitimacy of the encrypted ciphertext by establishing the area code permutation table. The disclosure uses the ZUC algorithm, Lagrange interpolation formula and modulo operation to perform encryption and decryption operations. Such an operation algorithm can perform format-preserving encryption on the phone number, and has a security equivalent to ZUC algorithm, which not only guarantees the accuracy and legality of encryption and decryption, but also hides the statistical features of plaintext in the ciphertext, and thus improves the efficiency of the algorithm and expands the applicability of commercial passwords. Therefore, the method proposed by the disclosure may have extremely high application value.

The disclosure has been described in details above in combination with specific embodiments. Without departing from the principles of the disclosure, those skilled in the art can also make various improvements and changes based on the embodiments in the above description and specific implementations. The scope of the invention is defined by the appended claims and equivalent thereof.

1. A format-preserving encryption method based on a stream cipher, comprising computer implemented steps of:
a) dividing a legal phone number into two parts comprising first three digits and last at least seven digits; and searching area codes of all legal phone numbers and creating a sorting rule to establish a corresponding area code permutation table by one-to-one mapping between a sequence number and the area code;
b) performing a summation and modulo-addition operation on a sequence number corresponding to a plaintext area code according to the permutation table established in the step a) and the last at least seven plaintext digits, to obtain an operation result as a new sequence number; and obtaining a new area code corresponding to the new sequence number according to the permutation table as an encrypted ciphertext of the plaintext area code;
c) converting each of the last at least seven digits of the phone number to a 4-bit binary number with insufficient highest bits filled with zero, to obtain a 32-bit binary number; then performing an XOR operation on the 32-bit binary number and a key stream of a ZUC algorithm; dividing an XOR result from right to left into groups of 4 bits with insufficient highest bits filled with zero and converting each of the groups into a decimal integer to be divided into 8 groups; performing a modulo-10 addition operation on divided results to obtain a conformal ciphertext data; further, based on a Lagrange interpolation formula, creating a polynomial on a prime field Z₁₇ by using the 8 groups of decimal numbers as secret values; and obtaining corresponding auxiliary data required during decryption by entering independent variables x in the polynomial;
d) connecting encrypted results obtained in step b) and step c) to obtain a legal ciphertext telephone number;
e) dividing the auxiliary data outputted in step c) into groups of 2 numbers for operation; taking out a first digit and remaining digits of each decimal auxiliary data as value x and value y respectively; performing a modulo operation by using the Lagrange interpolation formula; converting each of results of the modulo operation to a 4-bit binary number with insufficient highest bits filled with zero, to finally obtain a 32-bit binary number; performing an XOR operation on the 32-bit binary number and the key stream of the ZUC algorithm to obtain an XOR result; dividing the XOR result from right to left into groups of 4 bits with insufficient highest bits filled with zero, and converting each of the groups into a decimal integer, to be divided into 8 groups; and performing a modulo-10 subtraction operation on divided results to obtain a conformal plaintext data of the last at least seven digits;
f) searching a sequence number corresponding to a ciphertext area code obtained in the step b) according to the permutation table established in the step a); summing the last at least seven digits obtained in step e) and performing a modulo-subtraction operation; and restoring the plaintext area code by mapping a result of the modulo-subtraction operation to the permutation table; and
g) connecting decrypted results obtained in the step e) and the step f) to obtain a legal and correct decrypted plaintext telephone number.

2. The format-preserving encryption method based on stream cipher of claim 1, wherein in step c), in order to achieve correctness of a decryption algorithm, the polynomial on the prime field Z₁₇ is created by using the 8 groups of decimal numbers as secret values to obtain the auxiliary data required during decryption.

3. The format-preserving encryption method based on stream cipher of claim 1, wherein in steps c) and e), in order to achieve legitimacy and correctness of data encryption and decryption, the polynomial on the prime field Z₁₇ is created based on an idea of secret sharing scheme, and the Lagrange interpolation formula is used to perform auxiliary recovery on ciphertext data.

4. A format-preserving encryption method based on a stream cipher, comprising computer implemented steps of:
a) dividing a legal phone number into two parts comprising first three digits and last eight digits; and searching area codes of all legal phone numbers and creating a sorting rule to establish a corresponding area code permutation table by one-to-one mapping between a sequence number and the area code;
b) performing a summation and modulo-addition operation on a sequence number corresponding to a plaintext area code according to the permutation table established in the step a) and the last eight plaintext digits, to obtain an operation result as a new sequence number; and obtaining a new area code corresponding to the new sequence number according to the permutation table as an encrypted ciphertext of the plaintext area code;
c) converting each of the last eight digits of the phone number to a 4-bit binary number with insufficient highest bits filled with zero, to obtain a 32-bit binary number; then performing an XOR operation on the 32-bit binary number and a key stream of a ZUC algorithm; dividing an XOR result from right to left into groups of 4 bits with insufficient highest bits filled with zero and converting each of the groups into a decimal integer to be divided into 8 groups; performing a modulo-10 addition operation on divided results to obtain a conformal ciphertext data; further, based on a Lagrange interpolation formula, creating a polynomial on a prime field Z₁₇ by using the 8 groups of decimal numbers as secret values; and obtaining corresponding auxiliary data required during decryption by entering independent variables x in the polynomial;
d) connecting encrypted results obtained in step b) and step c) to obtain a legal ciphertext telephone number;
e) dividing the auxiliary data outputted in step c) into groups of 2 numbers for operation; taking out a first digit and remaining digits of each decimal auxiliary data as value x and value Y respectively; performing a modulo operation by using the Lagrange interpolation formula; converting each of results of the modulo operation to a 4-bit binary number with insufficient highest bits filled with zero, to finally obtain a 32-bit binary number; performing an XOR operation on the 32-bit binary number and the key stream of the ZUC algorithm to obtain an XOR result; dividing the XOR result from right to left into groups of 4 bits with insufficient highest bits filled with zero, and converting each of the groups into a decimal integer, to be divided into 8 groups; and performing a modulo-10 subtraction operation on divided results to obtain a conformal plaintext data of the last eight digits;
f) searching a sequence number corresponding to a ciphertext area code obtained in the step b) according to the permutation table established in the step a); summing the last eight digits obtained in step e) and performing a modulo-subtraction operation; and restoring the plaintext area code by mapping a result of the modulo-subtraction operation to the permutation table; and
g) connecting decrypted results obtained in the step e) and the step f) to obtain a legal and correct decrypted plaintext telephone number.

5. The format-preserving encryption method based on stream cipher of claim 4, wherein in step c), in order to achieve correctness of a decryption algorithm, the polynomial on the prime field Z₁₇ is created by using the 8 groups of decimal numbers as secret values to obtain the auxiliary data required during decryption.

6. The format-preserving encryption method based on stream cipher of claim 4, wherein in steps c) and e), in order to achieve legitimacy and correctness of data encryption and decryption, the polynomial on the prime field Z₁₇ is created based on an idea of secret sharing scheme, and the Lagrange interpolation formula is used to perform auxiliary recovery on ciphertext data.
